(19) United States
(12) Patent Application Publication
(10) Pub. No.: US 2007/0125450 A1
(43) Pub. Date: Jun. 7, 2007

(54) High-silicon steel and method of making the same

(76) Inventors: Dongliang Lin, Shanghai (CN); Hui Lin, Shanghai (CN)

Correspondence Address: BUTZEL LONG, 350 SOUTH MAIN STREET, SUITE 300, ANN ARBOR, MI, 48104, US

(21) Appl. No.: 10/580,664

(22) PCT Filed: Nov. 19, 2004
(86) PCT No.: PCT/CN04/01317

§ 371 Date: May 26, 2006

(30) Foreign Application Priority Data
Nov. 27, 2003 (CN) 200310108897.1

(51) Int. Cl. H01F 1/16

(52) U.S. Cl. 148/111

(57) ABSTRACT

A high silicon steel that comprises (by wt.) 5-10% silicon, 0.007-1% carbon; less than 0.01% impurities consisting of one or more of Mn, P, S, Cr and Ni; and balance Fe. A process for producing the high silicon steel involves the steps of adding 0.01-1% carbon to a high silicon steel comprising 5%-10% silicon, subjecting the steel to a homogenizing heat treatment in a protective atmosphere i.e. a solutionizing treatment between 1200° C. and at a temperature below the melting point of the steel, so that the constant-temp annealing of the steel eliminates most of the second phase in the silicon steel. The tensile ductility and workability of the silicon steel is improved so as to allow for mass production of high silicon sheets with various thicknesses. The process produces high silicon steel sheets in which the microstructure is controlled. In addition, final carbon content can be controlled to obtain high silicon steel sheets with optimal soft magnetism characteristics. The carbon-containing high silicon steel sheets can be utilized as a high strength constructional material at room and moderate temperatures in oxidizing and corrosive environments.

### FIELD OF INVENTION

The present invention relates to a silicon steel and method of making the same. More particularly, the present invention relates to a high silicon steel and method of making the same, which belongs to the field of material making.

### BACKGROUND OF THE INVENTION

High-silicon steel, i.e. steel containing 5 to 10 wt. % silicon (Si), less than 0.01 wt. % impurities and balance Fe, has excellent magnetic properties. For example, steel containing 6.5 wt. % Si has excellent magnetic properties such as near-zero magnetostriction, low core loss and high permeability. Such high-silicon steel, however, has poor ductility, which becomes progressively worse as the amount of Si increases. This poor ductility leads to poor workability, which makes it difficult to produce high-silicon steel articles using conventional metal-working methods. The combination of poor ductility and workability makes the production of high-silicon steel sheets especially difficult.

It is known that thinner high-silicon steel sheets have better soft magnetic properties. Thus, there is a desire to produce thin steel sheets. K. Okada et al., “Basic Investigation of CVD Method for Manufacturing 6.5% Si Steel sheet” (J ISIJ 1994, 80:777-784) discloses high-silicon steel sheets containing 6.5 wt. % Si that are produced by adding silicon to low-silicon (3 wt. %) steel sheets using a chemical vapor deposition (CVD) technique. This technique, referred to hereafter as “siliconizing”, is both costly and inefficient. In addition to the above drawbacks associated with current methods of producing high-silicon steel sheets, and in order to achieve desired magnetic properties, components that traditionally exist in steel must be avoided. For example, carbon is known to have a bad effect on the magnetic properties of high-silicon steel. For this reason, current high-silicon-steel normally contains much less than 0.01 wt. % carbon. This low carbon content is generally obtained by using high purity and costly starting materials.

### DESCRIPTION OF THE INVENTION

In order to overcome deficiencies associated with prior techniques, it is an objective of the present invention is to provide a thin, high-silicon steel sheet which uses conventional metal-working methods to solve the deficiencies mentioned above.

Accordingly, the present invention provides a high-silicon steel that comprises 5-10 wt. % silicon, 0.007-1 wt. % carbon; less than 0.01 wt. % impurities; and balance Fe.

The process of producing the high-silicon steel of the present invention involves the steps of adding 0.01-1 wt. % carbon to a high silicon steel comprising 5 wt. %-10 wt. % silicon, and subjecting the high-silicon steel to a homogenization process which has a temperature range from 1200° C. to just below melting point and a duration sufficient to substantially remove most of the secondary phases from the high-carbon steel. The homogenization process is carried out in a protective environment. According to the present invention, conventional metal working methods can be used to produce carbon-containing high-silicon steel sheets of various thickness. Depending on the individual process conditions, the final carbon content ranges from 0.04 wt. % for a sheet useful in mechanical applications, to 0.007 wt. %, for an annealed sheet useful in soft magnetic applications.

The homogenizing process utilized by the present invention significantly improves the tensile ductility and workability of a high-silicon steel over a wide temperature range, preferably from room temperature to about 900° C. The homogenization temperature range is from about 1200° C. to less than the melting point. The homogenization duration is defined as a time sufficient to substantially remove secondary phases, such as carbides and ordered BBC phases, from the high-silicon steel. This homogenizing process is carried out in a protective environment, defined in this invention as a non-oxidizing environment (e.g., an inert gas, such as Ar), a de-carburizing environment (e.g. hydrogen) or in a vacuum.

During the course of the present invention it has been discovered that the addition of substantial amounts of carbon, between 0.01 to 1 wt. % into a high-silicon steel in combination of the homogenization process described above, significantly improves the tensile ductility and workability over a wide temperature range, preferably from room temperature to about 900° C. Furthermore, the inclusion of carbon in the disclosed amounts results in a high-silicon steel that exhibits better mechanical properties.

In addition to a high-silicon steel described above, a process has been developed that enables such a steel to be produced having an elevated carbon level, defined as a carbon level of about 0.01 to 1 wt. %, when mechanical properties are desired. Alternatively, by using a process according to the present invention, the carbon content can be easily manipulated to allow the high-silicon steel to achieve optimum soft magnetic properties. For example, the inventive process, which is referred to as a thermo-mechanical control process (“TMCP”), results in a negligible amount of carbon, defined as less than 0.01 wt. % in the final composition. Since the inventive process does not require the use of either costly starting materials or a CVD siliconizing step, large-scale economic production of high-silicon steel sheets of varying thickness is possible.

According to the present invention, metal working methods can be used to produce carbon-containing high-silicon steel sheets of various thicknesses. For example, steel sheets have been produced that are less than 0.5 mm, e.g. having thicknesses of 0.5 mm, 0.35 mm and 0.1 mm. Controlled microstructures for such sheets would have substantially uniform grains approximating to the thickness of the sheet, e.g., on the order of 0.5 mm, 0.35 mm and 0.1 mm, respectively.

The metal working methods that can be used to produce carbon-containing high-silicon steel sheets according to the present invention include at least one of the following steps: (1) continuous casting and continuous hot rolling with rolling temperature between 600° C. and 1000° C., ingot casting is continuous hot-rolled at temperature between 600° C. and 1000° C.; (2) combinations of hot-rolling and cold-rolling (room temperature up to 500° C.) to produce thin sheets; (3) combinations of hot-rolling of a single sheet and hot-rolling of double or multiple sheets to produce thin sheets.

The process of the invention is unique in the fact that high-silicon steel is initially produced with an elevated carbon content, which increases workability, and thus facilitates the production of thin steel sheets, then a thermo-mechanical control process is used to produce a high-silicon steel with a controlled microstructure. A controlled microstructure is defined as a uniform grain size, which size is typically equivalent to the thickness of the sheet. Concurrent to producing a controlled microstructure, the TMCP process further enables the final carbon content to be tailored in such a way that the soft magnetic properties of the sheets are optimized. Typically, the final carbon content is controlled to be as low as possible. For example, to optimize soft magnetic properties, a carbon-containing high-silicon steel produced according to the present invention undergoes a suitable heat treatment step to reduce the carbon content and tailor the microstructure. Such a heat treatment step includes an annealing step at 800 to 1250° C. in a protective environment defined as a non-oxidizing environment (e.g., an inert gas, such as Ar), a de-carburizing environment (e.g. hydrogen) or a vacuum. Depending on the desired final properties, e.g., either optimum mechanical or magnetic properties, the protective environment can change.

In addition to soft magnetic properties, the carbon containing high-silicon steel produced according to the present invention has excellent mechanical properties. For example, it has a high yield strength from room temperature to 600° C. The steel also has excellent ductility over a wide temperature range. Therefore, it not only can be easily hot-rolled and cold-rolled, but the amount of allowable deformation in each step is sufficiently large to suit a wide range of existing rolling facilities. Thus, current metal working plants do not have to be re-tooled to perform this process.

For purpose of this invention, hot-rolling is defined as rolling at temperature from about 600° C. to about 1000° C., and cold-rolling is defined as room temperature up to about 500° C. The carbon containing high-silicon steel according to the present invention also has an excellent oxidation resistance at up to 500° C. Oxidation resistance is defined as the weight loss of the materials when exposed to a certain temperature, oxidizing environment.

According to one embodiment, of the present invention provides a high-silicon steel containing about 0.007 to about 1 wt. % carbon. A high silicon steel is defined as a steel containing from about 5 to 10 wt. % silicon. The present invention is also directed to a method of making a high-silicon steel with a controlled microstructure and carbon content to achieve optimum soft magnetic properties. For example, conventional melting techniques, such as induction melting, can used to produce a high-silicon steel according to the present invention. After using a conventional process, a thermo-mechanical control process can reduce the carbon content to a negligible amount. As a result, the use of high purity starting materials that are substantially free of carbon is not necessary in order to obtain high-silicon steel sheets for magnetic applications. Thus, the cost associated with producing high-silicon steel sheets for magnetic application can be reduced.

The silicon steel of the present invention has an elongation of at least 10% at room temperature, greater than 20% from 200° C. to 800° C., and greater than 100% at or above 800° C. The silicon steel of the present invention has a strength of about 600 MPa from room temperature to about 500° C., and an oxidation rate of 0.01 g/m² at 500° C. after 50 hours of air exposure. The silicon steel of the present invention exhibits the following magnetic properties: a maximum permeability of 46,000 μm, a core loss at different frequency ranges, of W_{10/50}=0.49 w/kg, W_{10/400}=10.56 w/kg, W_{5/1K}=11 w/kg, W_{1/5K}=8.71 w/kg, W_{0.5/10}=6.5 w/kg.

The present invention improves the tensile ductility and workability of the silicon steel remarkably, so large-scale economic production of high-silicon steel sheets of varying thickness made possible. The thermo-mechanical control process can not only be used to produce a silicon steel with a controlled microstructure, but it also enables the final carbon content to be tailored in such a way that the soft magnetic properties of the sheets are optimized. Therefore the carbon-containing high-silicon steel of the present invention can be used as a high-strength structural material in oxidizing and corrosive environments at both ambient and moderately high temperatures.

### BRIEF DESCRIPTION OF THE DRAWINGS

FIG. 1 is a plot of tensile ductility, yield strength and tensile strength as a function of temperature for carbon containing steel hot-rolled at 700° C. and annealed at 750° C. for 140 minutes; and

FIG.2 is a plot of tensile ductility, yield strength and tensile strength as a function of temperature for carbon containing steel hot-rolled at 1000° C.

### EXAMPLES

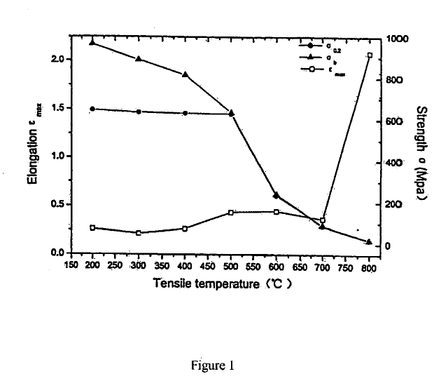

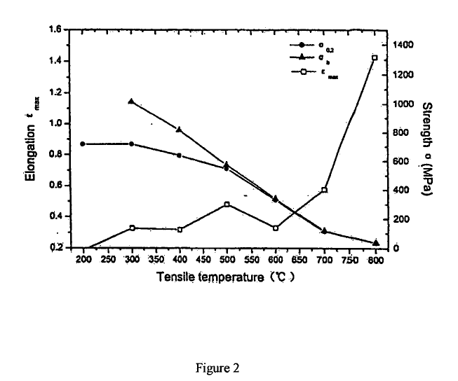

The following examples in conjunction with FIG. 1 and FIG. 2 illustrate certain aspects of the invention, but should not be taken as limiting the scope of the invention.

A carbon containing high-silicon steel was produced that contained the following composition: 5-10 wt. % Si, 0.007-1 wt. % carbon, less than 0.01% impurities consisting of Mn, P, S, Cr and Ni, balance iron. All high-silicon steel examples made from the carbon containing high-silicon steel went through a homogenization process that had a temperature range from 1200° C. to just below melting point. The duration of the homogenization process was sufficient to substantially remove most of the secondary phases from the high-carbon steel. The homogenization process was carried out in a protective environment. Depending on the individual process conditions, the final carbon content ranged from 0.04 wt. % for a sheet used in mechanical applications, to 0.007 wt. %, for an annealed sheet used in soft magnetic applications.

As shown below, the resulting high-silicon steel exhibited an excellent combination of mechanical, oxidation resistance and corrosion resistance properties. Furthermore, depending on variations conventional metal working processes, one or more of these properties can be changed.

### Example 1

In this example a carbon containing high-silicon steel was produced that had the following composition: 5 wt. % Si, 1 wt. % carbon, less than 0.01% impurities consisting of one or more of Mn, P, S, Cr and Ni, balance iron. A sample of this carbon containing high-silicon steel having gone through the above-stated homogenization process was hot-rolled at 700° C. and then annealed at 750° C. for 140 minutes. The mechanical properties associated with this example are shown in Fig. As can be seen in FIG. 1, the tensile ductility is over 20%, from about 200 to 400° C. and increases to over 40% from 500 to 600° C. and is over 200% at about 800° C. While not shown in FIG. 1, the tensile ductility is over 10% at room temperature. The yield strength of this sample is about 600 MPa at 200 to 500° C.

### Example 2

In this example a carbon containing high-silicon steel was produced that had the following composition: 6.5 wt. % Si, 0.007 wt. % carbon, less than 0.01% impurities consisting of one or more of Mn, P, S, Cr and Ni, balance iron. A sample of this carbon containing high-silicone steel was hot-rolled at 1000° C. The mechanical properties associated with this example are shown in FIG. 2. As seen in FIG. 2, the tensile ductility is over 15% at 200° C. and increases to over 60% at 500° C. The yield strength is 700 MPa at 200 to 400° C. and 550 MPa at 500° C.

### Example 3

To order to show the workability properties associated with the carbon containing high-silicone steel of the present invention, a sample of the carbon-containing high-silicon steel homogenized according to Example 1 was hot-rolled through multiple steps to produce sheets having thicknesses as thin as 0.35 mm. The rolling temperature was between 600° C. and 1000° C. to take advantage of the superplasticity in that temperature range. The thickness of carbon-containing high-silicon steel sheets was further reduced through cold-rolling at temperatures above 200° C. If desired, the carbon content of this steel could be minimized by an appropriate annealing step. Such a step would be performed if optimum soft magnetic properties were desired.

### Example 4

In order to show the soft magnetic properties associated with the carbon containing high-silicone steel of the present invention, a sample of carbon-containing high-silicon steel homogenized according to Example 1 was made into a sheet of approximately 20 mm thick. This starting sheet was subsequently hot-rolled at 1000° C. After multiple rolling steps, the last of which was performed at approximately 600° C., a high-silicon steel of approximately 0.35 mm was formed. The sheet was then annealed for 2.5 hours at 1130° C. in a hydrogen atmosphere. At this annealing time and temperature it is anticipated to be able to obtain steel of minimal carbon content, and produce the following soft magnetic properties: maximum permeability of 46,000 μm, a core loss at different magnetic field/frequency (Gs/Hz) ranges, of W_{10/50}=0.49 w/kg, W_{10/400}=10.56 w/kg, W_{5/1K=}11.5 w/kg, W_{1/5K}=8.71 w/kg, W_{10/400}=6.5 w/kg. Since the inventive process does not require the use of either costly starting materials or a CVD siliconizing step, large-scale economic production of high-silicon steel sheets of varying thickness made possible.

### Example 5

According to this example, a carbon containing high-silicon steel was produced that had the following composition: 10 wt. % Si, 0.4965 wt. % carbon, less than 0.01% impurities consisting of one or more of Mn, P, S, Cr and Ni, balance iron. A sample of this carbon containing high-silicon steel was hot-rolled at 1000° C. The resulting silicon steel exhibited the following mechanical properties: The tensile ductility is over 15% at 200° C. and increases to over 60% at 500° C. The yield strength is 800 MPa at 200 to 400° C. and 650 MPa at 500° C.

1. (canceled)

2. A method of making a silicon steel, said method comprising adding about 0.01 to about 1.0 wt. % carbon to a steel containing from about 5 to 10 wt. % Si and subsequently homogenizing said steel at a temperature from about 1200° C. to up to less than the melting point of said steel for a time sufficient to substantially remove most of the secondary phases from said steel, said homogenization process being carried out in a protective environment.

3. A method according to claim 2, wherein said protective environment comprises at least one of a non-oxidizing environment, a de-carburizing environment and a vacuum.

4. A method according to claim 2, further comprising using a thermo-mechanical process to adjust the carbon content of the high silicon steel.

5. A method according to claim 2, further comprising producing carbon-containing high-silicon steel sheets from the high silicon steel.

6. A method according to claim 5, wherein said carbon-containing high-silicon steel sheets are produced by at least one of: (1) continuous casting and continuous hot rolling with a rolling temperature between 600° C. and 1000° C.; (2) combinations of hot-rolling and cold-rolling with temperatures between room temperature and up to 500° C. to produce thin sheets; and (3) combinations of hot-rolling of a single sheet and hot-rolling of double or multiple sheets to produce thin sheets.

7. A method according to claim 2, wherein the high silicon steel has a room temperature ductility of at least 10%; an elongation of greater than 20% from 200° C. to 800° C., and greater than 100% at or above 800° C.; a strength of about 600 MPa from room temperature to about 500° C.; an oxidation rate of 0.01 g/m² at 500° C after 50 hours of air exposure; and exhibits the following soft magnetic properties: maximum permeability of 46,000 μm, a core loss at different frequency ranges, of W_{10/50}=0.49 w/kg, W_{10/400}=10.56 w/kg, W_{5/1K}=11 w/kg, W_{1/5K}=8.71 w/kg, W_{0.5/10}=6.5 w/kg.

8. A method according to claim 5, wherein the carbon-containing high-silicon steel sheets are produced with thickness of 0.5 mm or less.

9. A method according to claim 8, wherein the carbon-containing high-silicon steel sheets are produced with of from about 0.1 mm to about 0.5 mm.

10. A method according to claim 5 wherein the carbon-containing high-silicon steel sheets are produced with microstructures that have substantially uniform grains that approximate the thickness of the sheets.

11. A method according to claim 8 wherein the carbon-containing high-silicon steel sheets are produced with microstructures that have substantially uniform grains that approximate the thickness of the sheets.

12. A method according to claim 9 wherein the carbon-containing high-silicon steel sheets are produced with microstructures that have substantially uniform grains that approximate the thickness of the sheets.
